(19) United States
(12) Patent Application Publication
(10) Pub. No.: US 2011/0225027 A1
(43) Pub. Date: Sep. 15, 2011

(54) Global Competitive Positions

(76) Inventor: Sebastian Ignacio Herrera Schuvab, Buenos Aires (AR)

(21) Appl. No.: 12/239,126

(22) Filed: Sep. 26, 2008

Related U.S. Application Data
(60) Provisional application No. 60/975,567, filed on Sep. 27, 2007.

(51) Int. Cl. G06Q 30/00

(52) U.S. Cl. 705/14.4; 705/26.1

(57) ABSTRACT

A system to determine the global competitive position of every product manufactured in the world. We define global competitive position as the margin in price that a product presents when compared to similar or equal products offered in other countries. With the idea of comparing all products on an equal basis, we have also incorporated the duties and taxes that must be paid to be delivered door to door in other countries. These global competitive positions show an important utility on e-commerce, which allows us to determinate the yield margin of a product. Consequently, this determination permits the promotion of products that we know to be competitive in foreign markets. This dispersion of competitive situations, based on global positions, impacts and modifies the actual competitive situation of the products manufactured, the companies that manufacture these products, the investors that finance these goods and the consumers that acquire them.

The following invention claim priority date on Sep. 27, 2007 based on the provisional application Ser. No. 60/975567.

### FIELD OF THE INVENTION

The present invention is related to electronic merchandise catalogue and ordering systems for international e-commerce and financial platforms. More particularly, it relates to an international multi-channel platform covering international competitive analyses of products, international customs regulations and worldwide logistical services, in order to unite supply and demand worldwide.

### BACKGROUND OF THE INVENTION

All products manufactured in the world go through different steps and operations, since they are created up to the moment when are delivered to consumers. These operations include:
Investment to produce them.
Promotion to reach consumers.
Commercialization of products—sale, charge and delivery operations—.
Financing product acquisitions, giving credit to consumers.

We can infer the following participants are involved within these manufacturing operations over products:
Sellers.
Buyers.
Promoters.
Investors.

Operating through online commercial platforms, affiliates systems for product promotions and financial services. Consequently, we can identify an important variety of industries working on these processes:
E-commerce platforms and multi-channel selling platforms part of Internet software & Services industry, focusing operations in sellers and buyers.
Affiliates systems, part of the advertising industry focusing operations in online promoters.
Financial systems services, part of investment brokerage industry focusing in investors.

The first industry under analysis in order to define the current state of technology referred to e-commerce solutions and provide sufficient information about specific problems involved in the state of technology which our invention is drawn toward, will be the Internet software & Services Industry. Analyzing this industry, a general situation appears repeatedly. Most of sellers and buyers operating nowadays on these platforms focus their operations in their home country alone. These operations work in a similar way that offline channels work. Nevertheless, these channels show important differences in their operations.

The most important difference between channels lies in the fact that offline channels need local stock to operate. Consumers operating through offline channels will pick up or buy products inside offline stores. On the other hand, online channels could operate with local or international stocks; their products will be delivered to consumers using express mail services, so it is not an issue if they have those products inside each country or in other countries. With the idea to enhance the comprehension, we will explain purchases process among consumers. When online consumers acquire a product, generally two variables act as purchase trigger to define between two sellers:
First, an online consumer will choose one seller rather than another based on the price of the product, given that the products possess equal or similar characteristics.
Second, transit time and shipping costs will define a preference for one seller instead of others.

Therefore we can assume that it is not important for online consumers if these products are located and shipped from a domestic distribution center or from a distribution center or manufacturing facility located in another country.

Nowadays most companies operate using a traditional vision in logistical solutions. By traditional vision we refer to the process of acquiring large quantities of products from foreign companies or distributors, and sending those products to local distribution centers in each country where they operate. When those products are located in the distribution center, online companies promote and sell these products using online channels.

Sellers list these products on their web pages or through online commercial platforms to reach consumers. When a consumer acquires a product, the seller will charge them using a payment gateway system and will ship using courier services directly to consumers—with a domestic transit time of 24 hs to 96 hs.

Sellers promote products using:
Online auction web sites.
Price comparison websites.
Corporate self operated e-commerce web sites.
Social networking platforms.

Despite the fact that sellers promote their products using multi-channel strategies, most of these strategies are for local buyers only. It is not common to find companies selling abroad to consumers, through multi-channel strategies with campaigns or advertising in foreign countries. The main reasons for this situation are the logistical complexity of international operations and a lack of knowledge in customs regulations. Further cases which display this domestic approach are e-commerce competitive analyses. It is not common to observe operations or competitive analyses that take into consideration similar products in other countries. Sellers and buyers compare products with similar products located in their countries alone. They analyze product competitiveness by comparing them with other similar products offered by sellers inside their countries. As most companies follow the typical acquisition process previously described, most of these products offered to consumers in each market show similar characteristics and price.

It is rare to observe analyses which take into account similar products located in other countries, despite the fact that these products have the potential to reach the same consumers with similar transit time as local proposals. This local vision is not only a common situation among sellers; most of actual e-commerce platforms present this characteristic too. Typical domestic approach displayed by e-commerce platforms are the content categories displayed in these transactional systems. It is common to observe worldwide e-commerce companies offering the same Application Programming Interface to generate transactions in many countries but, on the other hand, each country develops their own tree of categories presenting different content within the same platform. As a consequence of this domestic approach, if a consumer wants to list his/her product through all English content sites—E.G.: U.S., U.K., Canada, Australia—in one single action, this would not be possible—at present—, because they would need to select the appropriate category for their product in each country.

Analyzing worldwide e-commerce companies and patents created to provide an international shopping experience—e.g.: U.S. Pat. No. 6,460,020 to Pool et al.—, shows that none of these systems display or incorporate the comparison of the delivery duty paid price determination versus the average price paid by consumers, in order to estimate the competitive position of a product compared with similar or equal proposals located in another country.

Consequently, we can infer an increasing necessity among sellers and buyers working in the Internet software & Services industry. This necessity focuses on the acquisition of new tools, giving them the chance to operate and promote products through local and international channels all in one source. By using these tools, they will increase penetration into the entire world market and obtain the greatest possible benefits for their products. For our analysis we assume that this worldwide penetration will need:
First: tools for sellers that permit them know where they can compete profitably and at what price margin they can promote their products. Sellers must know the price consumers will pay to receive these products delivered in other countries.
Second: sellers and buyers must have an international e-commerce multi-channel system to operate worldwide. This system must cover international competitive analyses of products, international customs regulations and worldwide logistical services, in order to unite supply and demand worldwide.

The second industry under analysis in order to define the current state of technology referred to e-commerce activities and provide sufficient information about specific problems involved in the state of technology which our invention is drawn toward, will be the advertising agencies industry, focusing on affiliates and partners online systems. We can define these systems through affiliates and partners as a model wherein participants promote products with the goal of receiving a commission over the sales price for each product sold. Current affiliate systems offer to participants the following characteristics for product selection:
Category of products where they want to operate.
Earnings per click that show each product—EPC—.
Advertising format.

Earnings per click—EPC—measures show an interesting characteristic. Similar products using different types of advertising formats present different types of EPC measure. Thus, the advertising format seems to be more important than the product for this statistical measure. We can infer the EPC statistic is an important tool used by affiliates when selecting the product and advertising format to promote and generate sales leads. But this statistical measure cannot estimate for affiliates the value consumers would receive selecting one product over another based on price comparison with similar or equal proposals inside their home country or abroad. Additionally, the participant cannot define the sale price of the products they promote. They act as a promotional channel with no input in the commercial proposal set up. If they want to promote products over the price stipulated by the seller to earn more profits, they find that they cannot perform this action. Based on the previous analysis, we can infer that the current state of the art is not covering a necessity among promoters working in the advertising agencies industry. This necessity focuses on two variables:
First: the incorporation of a variable that lets them knows the value for a consumer that a particular advertising proposal has compared with similar products proposals offered in the same market based on price comparison. This comparison will give participants the chance to estimate the potential this campaign has to generate sales leads.
Second: the incorporation of a variable that lets them know the best price to sell a product, plus the chance to set up the price for this particular campaign. This will grant participants the ability to obtain greater benefits, based on his/her expertise of the community of consumers visiting his/her web page.

The third industry under analysis in order to define the current state of technology referred to e-commerce activities and provide sufficient information about specific problems involved in the state of technology which our invention is drawn toward will be Investment brokerage, covering investment processes and credit to support operations focused on the products. Two major situations appear analyzing the present financial situation for manufacturing and retail companies:
First, financial operations for products focus mainly on commodities. In the present financial situation, all other products with standardized characteristics—such as electronic products—are not included in typical commodities operations.
Second, most companies operating nowadays on products have a market capitalization that it is lower of what it is expected in order to list their securities on international stock exchanges. Due to actual regulations and requirements, it is very expensive and difficult for these companies to raise money by listing their companies in stock exchange markets. Analyzing why it is so difficult for small market capitalization companies to finance operations, the most common situation resides in the lack of information for these companies that investors can find on daily basis, considering this securities a risky bet.

Focusing on the first point, nowadays in stock markets we can assume that investors' trade in products—commodities—performing different kind of operations in one or many markets. These operations have increased the amount of money traded in products during the last two decades. But, despite the fact that this industry constantly seeks new financial products offering increasing profit, we observe a paradoxical situation in products as they only cover basic resources and agricultural products generally defined as commodities. Financial operations trading in resources and agricultural commodities began long ago, offering to all participants an easy way to understand each other, providing the financial mechanism to operate in these kinds of products. This understanding between parts was based on the following characteristics:
Commodity products show standardized constitutive characteristics;
Commodity products refer mainly to raw materials and basic products;

In the past, product simplicity was a requirement that let participants understand in what they were trading in. Nowadays however, electronic systems allow processing large amounts of information in seconds. These electronic systems give us the chance to standardize and analyze more products with similar constitutive characteristics—e.g.: electronic equipments—, giving us the possibility to incorporate these products into financial operations as happens with resources and agricultural commodities. Thus, any platform with the ability to process and compare similar or equal products traded through different markets will be able to replicate these successful financial systems such as is happening with commodities.

Regarding Markets and information, the primary function of an exchange is to provide liquidity; in other words, to give sellers a place to “liquidate” their share holdings. Analyzing why Micro and Small Capitalization stocks—typical small and medium companies operating worldwide—are so difficult for investors to place their money, we can find the following situation:
Lack of Public Information: The biggest difference between a micro capitalization stock and other stocks is the amount of reliable, publicly available information about the company.
No Minimum Listing Standards: Companies that trade their stocks on major exchanges and in the NASDAQ Stock Market must meet minimum listing standards. For example, they must have minimum amounts of net assets and minimum numbers of shareholders.
Risk: While all investments involve risk, micro capitalization stocks are among the most risky. Many micro cap companies tend to be new and have no proven track record. Some of these companies have no assets or operations. Others have products and services that are still in development or have yet to be tested in the market. Another risk that pertains to micro cap stocks involves the low volumes of trades. Because micro cap stocks trade in low volumes, any size of trade can have a large percentage of impact on the price of the stock.

As the SEC—U.S. securities exchange commission—says: “Information is the investor's best tool when it comes to investing wisely. But accurate information about “micro cap stocks”—low priced stocks issued by the smallest of companies—may be difficult to find“. When reliable information is scarce, fraudsters can easily spread false information about micro cap companies, making profits while creating losses for unsuspecting investors. Based on this situation, its hard for investors to get the facts about the company's management, products, services, and finances and invest on them; despite the fact the most promising stock is available on those small markets. Any platform with the possibility to increase the amount of information of micro and small capitalization companies—measuring the online credibility that they display through different e-commerce platforms and competitiveness that their portfolio of products show throughout the world compared with similar or equal portfolio of products—, would be able to broaden the investment market. By providing more tools for the investment community, participants will be able to invest on promising companies on the same way they invest on big capitalization companies. Consequently, based on this analysis we can infer an increasing necessity for the investment brokerage industry, looking to:
Enhance and broaden financial proposals covering more products for investors.
Enhance and broaden financial information covering more companies and industries for investors.

Looking at the same industry, but focusing on credit for online consumers, it is common to find the following situations:
The credit level of a consumer with his/her financial institution, will define the amount of money this participant will be granted to finance products acquisitions.
Liquidity level that financial institutions have during a certain period of time, will define their readiness to offer credit to consumers.

But as we observe, credit promotions focus analysis on financial institution situations. Market situations are not part of the analysis when consumers acquire products. In general, the decision to provide credit for consumers focuses on the idea of increasing sales. Although analysis focusing on demand estimates the level of competition for a particular product, it is not part of the actual credit proposal for online consumers. For sales conversions, would not be the same if a product competes with 100 similar products in one location, than if that product competes with 5000 products at the same location with similar prices. The necessity to broaden proposals generating more sales conversions by using credit would be greater in the second example than in the first one, with 100 products only.

Based on this analysis, we can infer an increasing necessity to find tools to estimate competition level in a particular market, which let sellers know the amount of credit or discounts they must offer to attract consumers' acquisition preferences.

### SUMMARY

The method for the determination of the global competitive position begins with the premise that every product manufactured in the world has a global competitive position.

We define global competitive position as the margin in price that a product presents when compared to similar or equal products offered in other countries. With the idea of comparing all products on an equal basis, we have also incorporated the duties and taxes that must be paid for the product to be delivered door to door in other countries. These global competitive positions show an important utility on e-commerce, which allows us to estimate the yield margin of a product. Consequently, this determination permits the promotion of products that we know to be competitive in foreign markets. This generates a totally new dispersion of competitive situations in international commerce. The growing worldwide competition erases the barriers for products, reaching the consumers, while using the same kind of commercial platforms, the same kind of payment systems, and the same kind of logistical systems, changing the actual situation in worldwide commerce.

Within these new circumstances, e-commerce participants and their products become worldwide competitors. Participants understand that these products compete in transit time and price with similar or equal products located in other countries. This dispersion of competitive situations, based on global positions, impacts and modifies the actual competitive situation of the products manufactured, the companies that manufacture these products, the investors that finance these goods and the consumers that acquire them.
The determination of the global competitive position of a product: permits to know in how many places they are competitive and at what price margin, when compared to similar or equal products sold in other countries. This analysis provides participants an appreciation of the benefit to be received for the promotion and sales of these products in a particular market.
The determination of the global competitive position of a company, based on their portfolio of products: permits to know the competitiveness of a company based on the sum of global competitiveness of the products that it manufactures, giving us a certain measure of the capabilities that this company has to generate benefits in the entire world.
The determination of the global competitive position of investors through their investment portfolio in manufacturing and retail companies: permits to know the competitiveness of an investor based on the sum of global competitiveness of the companies which make up their investment portfolio, giving a certain measure of the capabilities that these selections have, to obtain benefits all over the world.
The determination of global competitive position of consumers in the world, based on their location and online profile: permits to know the level of competition of a product in a particular market and estimate the possibility that this commercial message has to reach the consumer. With a greater level of competition it is possible to broaden this proposal incorporating more discounts or credit.

Based on this situation, the strategic vector of the system will focus on the determination of global competitive positions of the participants, to increase the penetration of their proposals in order to obtain the greatest possible benefits for their operations. Through these analyses, the system plans to provide all participants with tools in order to make all products accessible worldwide through the determination of the global competitive position, to facilitate the process for the participants to reach pricing objectives and obtain the greatest possible benefits.

### BRIEF DESCRIPTION OF THE DRAWINGS

FIG. 1: COMPETITIVE POSITION OF A PRODUCT BETWEEN TWO COUNTRIES,

This figure shows the process for the determination and comparison of the Delivery Duty Paid price (DDP) of a product versus the average price of similar products in other countries. This analysis permits us to know in how many places the product is competitive and at what price margin. The system estimates the yield margin of a product in other countries, based on 3 variables:
The origin country of the product.
Origin price of the product—FOB Price—.
The characteristics each product has that can be standardized using harmonized code in each destination country;

Through these three variables we can determine the price value in order to proceed with the comparison between the delivery duty paid price (DDP) of the product located in a foreign country, versus the average price displayed by similar products located in the market of analysis.

FIG. 2: GLOBAL COMPETITIVE POSITION USING A MULTINATIONAL APPROACH,

This figure explains the way we can estimate the global competitive position of a product in other countries around world. This analysis compares the amount of money a consumer will pay to have a product delivered including duties and taxes. Consequently, these analyses provide sellers with a multinational approach to estimate the global competitive position of their products in other countries, letting them know in how many places these products are competitive and at what price margin. This information offers the possibility to promote products that they know to be competitive.

FIG. 3: PROMOTION, SELLING OF GOODS THROUGH THE GLOBAL COMPETITIVE POSITION SYSTEM,

This figure explains the growing worldwide competition. International sellers using the same kind of commercial platforms, the same kind of payment systems, and the same kind of logistical systems as used by local sellers, can list globally competitive products on major online commercial platforms through the system.

FIG. 4: CHARGING CREDIT CARDS AND SHIPPING PRODUCTS FROM PRODUCERS TO THE FINAL CUSTOMERS THROUGH THE GLOBAL COMPETITIVE POSITION SYSTEM

When a consumer acquires a product, a sale order is generated and informs to the sellers company. As it is observed in the graph, the supplies of the consumers are channeled towards the system by the commercial platforms to our gateway of payments. The gateway of payments system process the transaction, each participant receives their amount of money, less the charges and commissions of the system. As it is observed in the situation, our gateway pays the producer the FOB price plus the margin at destination. Margin at destination is defined as the calculation of the average price less DDP Price.

An amount of the sales price is assigned for duties and taxes. Participants could receive their money using direct transfer to their bank accounts—if they have a merchant id -or in a monthly transfer with all the transactions.

FIG. 5: DETERMINATION OF THE GLOBAL COMPETITIVE POSITION OF CONSUMERS, USING A WEB PAGE TO DISPLAY PRODUCTS

The system offers consumers the best price available for products located in the world, Through Web services calls to major commercial platforms, the system will estimate the price of products delivered directly to the door of a consumer in a particular market. In this model the system displays international products using a percentage of discounts over the average price of similar products on that category in that location. This variable will be defined manually or through the determination of the category competition of products available for that consumer in a particular market.

FIG. 6: PRODUCT ALERT SYSTEM FOR CONSUMERS

This figure explains the product alert feature. Consumers set up their choices of products and the maximum price they are willing to pay. If a product located somewhere in the world displays a DDP price below the local average price for the same kind of product, the consumer receives a notification or direct purchase based on his set-up preferences.

FIG. 7: AUTOMATED PRICE SPREAD SYSTEM TO ARBITRATE WITH PRODUCTS BETWEEN MARKETS

This figure explains the process generated by the system in order to arbitrate with competitive products between markets. Through web services calls to major platforms in selected categories, products are analyzed by the global competitive position system and list the price competitive products in other platforms and countries in the world to obtain the price margin.

FIG. 8: AFFILIATE PROGRAM SYSTEM

This figure explains the process and the way affiliates promote competitive products with the idea to receive the margin at destination for each product sold by their commercial effort. The affiliate system brings participants a platform to promote price competitive products—analysis based on price comparison directly to consumers in each location that they are operating in, providing advertising feeds to participants and delivering the best prices for products available worldwide to a consumer in a particular location.

FIG. 9: PARTNER PROGRAM SYSTEM

This figure explains the process and the way partners promote competitive products with the idea to receive the margin at destination for each product sold by their commercial effort. The partner system brings participants a platform to promote competitive products by providing them with the possibility to earn the margin at destination for each product sold by their commercial effort, through listings in major commercial platforms and advertising campaigns paid for by these participants.

FIG. 10: GLOBAL COMPETITIVE POSITION OF A COMPANY

This figure shows the way that is estimated the global competitive position of a company. The system offers a tool to estimate the competitiveness of a company based on the sum of global competitiveness of the products manufactured by them, based on the yield price margin displayed and the number of countries in which those products show a positive competitive position.

FIG. 11: GLOBAL COMPETITIVE POSITION OF AN INVESTOR

This figure shows the way that is estimated the global competitive position of an investor. The system offers a tool to estimate the competitiveness of an Investor or Venture capital firm, based on the sum of global competitiveness of the manufacturing and retail companies which make up their portfolio. This tool gives a determination of the capabilities that this participant—investor—has, in obtaining benefits on each industry category in all over the world.

FIG. 12: GLOBAL COMPETITIVE POSITION OF A CONSUMER REQUESTING CREDIT TO AQCUIRE PRODUCTS

This figure shows the way that is estimated the global competitive position of a consumer requesting credit in order to acquire a product. The system offers a tool to estimate the global competitive position of a consumer based on their location and online profile to broaden commercial proposal incorporating credit.

### DETAILED DESCRIPTION OF THE EMBODIMENT

The detailed description of the embodiment comprises an exhaustive analysis of the system to determine the global competitive position of products, companies, investors and consumers. In order to define the meaning of important phrases stated at the explanation of the system we will say that:
The determination of the global competitive position of a product is defined as the margin in price that a product presents when compared to similar or equal products offered in other countries. With the idea of comparing all products on an equal basis, we have also incorporated the duties and taxes that must be paid to be delivered door to door in other countries. The determination of these global competitive positions shows an important utility on e-commerce, which allows to estimate the yield margin that a product displays on different markets throughout the world. Consequently, this determination permits the promotion of products that it is known to be competitive in foreign markets.
Positive global competitive position means that the product in country A displays a delivery duty paid—DDP—price lower than the price display by similar or equal products located at country B.
Negative global competitive position means that the product in country A displays a delivery duty paid—DDP—price higher than the price display by similar or equal products located at country B.
Neutral global competitive position means that the product in country A has a delivery duty paid—DDP—price displaying the same cost compared with the average price of similar or equal products located at country B.
The margin at destination is defined as the calculation of the average price that a product has on each country, less the Delivery Duty Paid Price that similar or equal products located in another country has for the market of analysis.
The determination of the global competitive position of a company based on their portfolio of products, is defined as the sum of global competitiveness of the products that it manufactures, determining a certain measure of the capabilities that this company has to generate benefits in the entire world.
The determination of the global competitive position of investors through their investment portfolio in manufacturing and retail companies is defined as the competitiveness that an investor's portfolio shows based on the sum of global competitiveness of the companies which make up their investment portfolio, giving a certain measure of the capabilities that these selections have, to obtain benefits all over the world.
The determination of global competitive position of consumers in the world, based on their location and online profile is defined as the level of competition that a product in a particular market shows in order to determine the possibility that this commercial message has to reach a consumer. With a greater level of competition—this means the amount of price competitive products towards that particular location—, will be necessary to broaden this proposal incorporating more discounts or credit with the idea to obtain consumers attention.

This dispersion of competitive situations, based on global positions, impacts and modifies the actual competitive situation of the products manufactured, the companies that manufacture these products, the investors that finance these goods and the consumers that acquire them. As a consequence, the detailed description of the embodiment groups the figures into these four operational logics: products, companies—producers, commercial affiliates and partners-, investors and consumers inside the global competitive position system, serving different segments of users and needs.

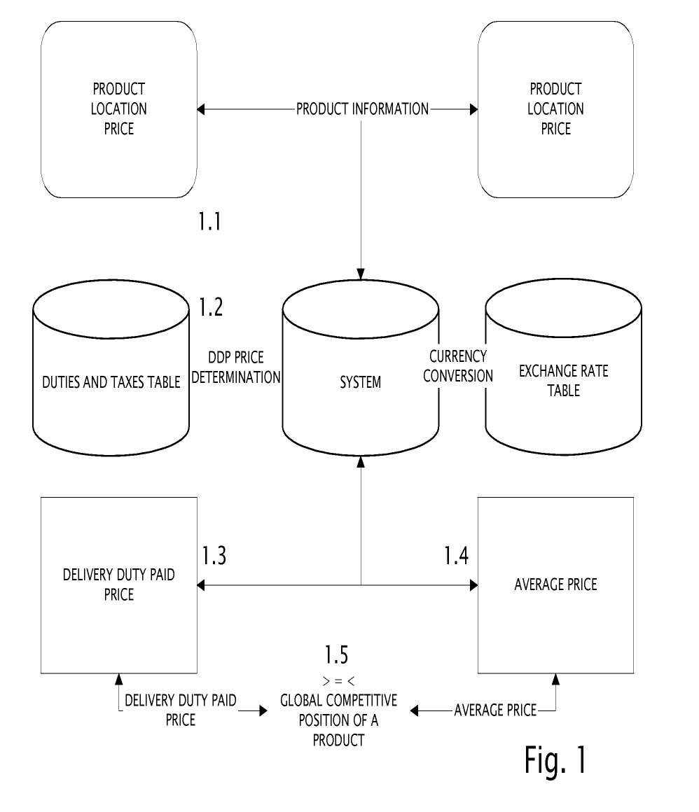

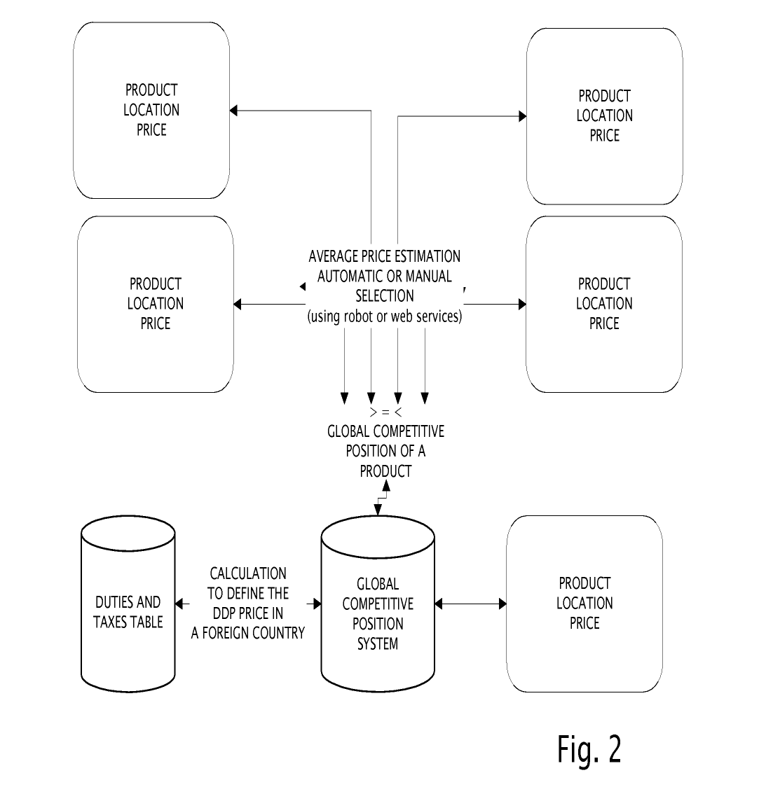

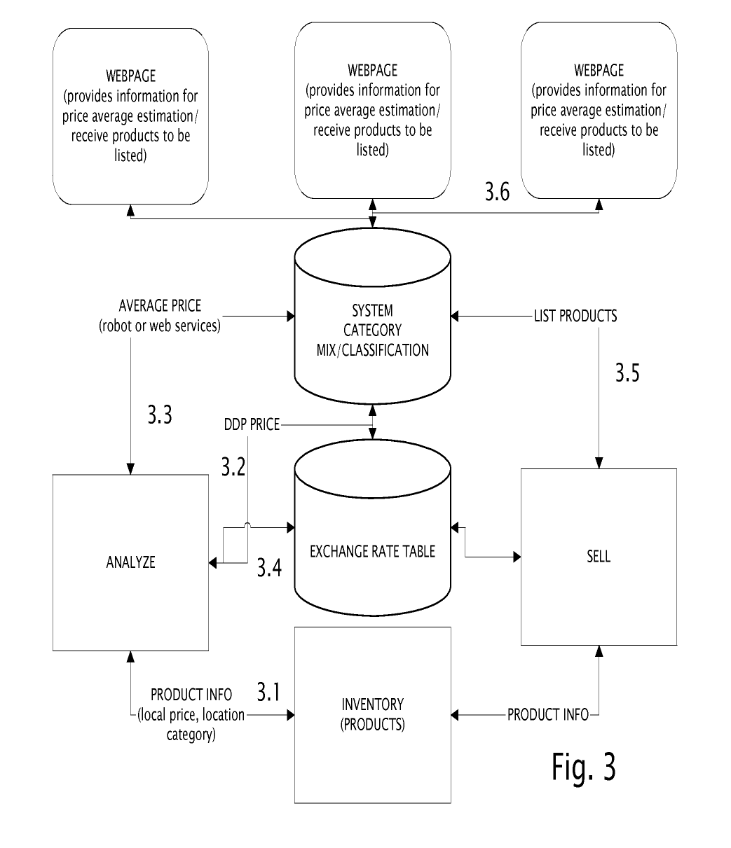

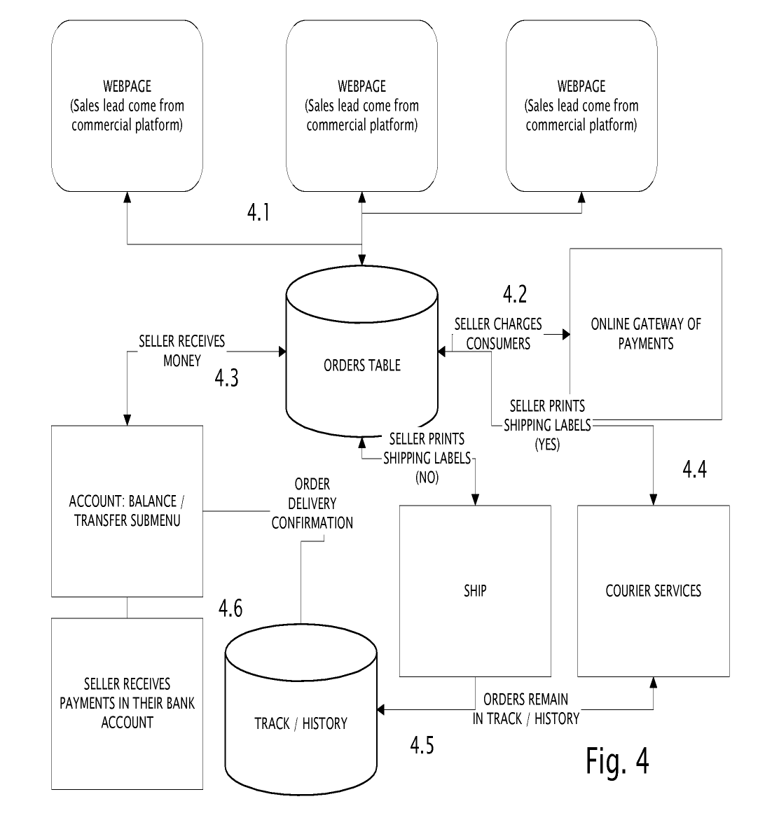

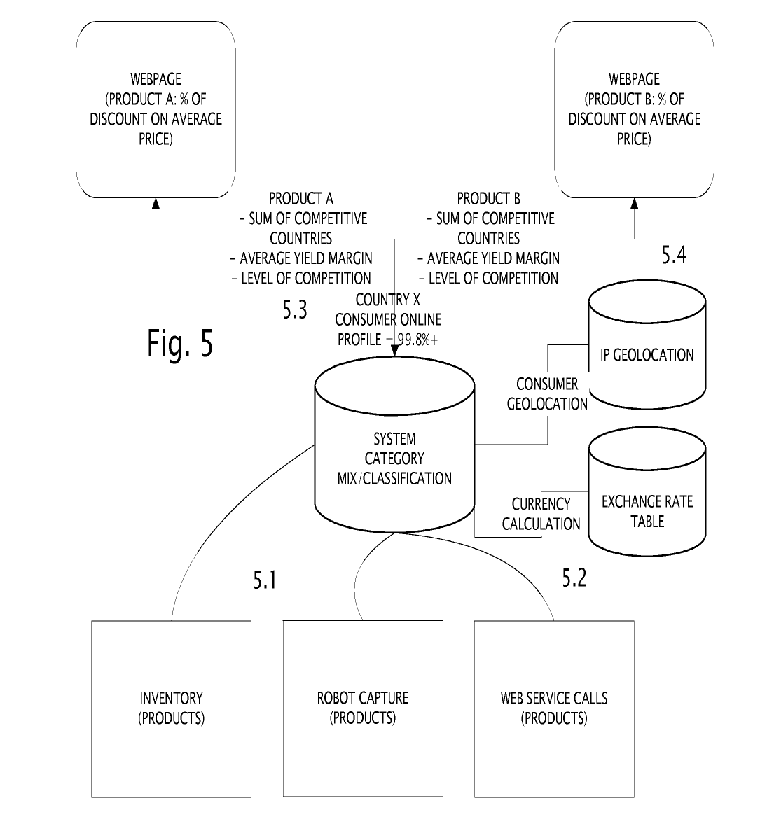

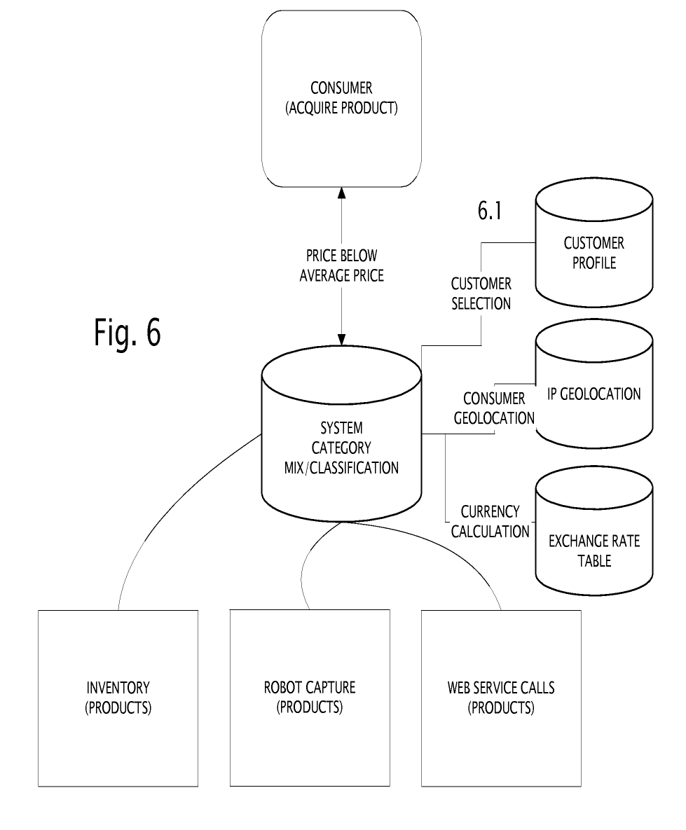

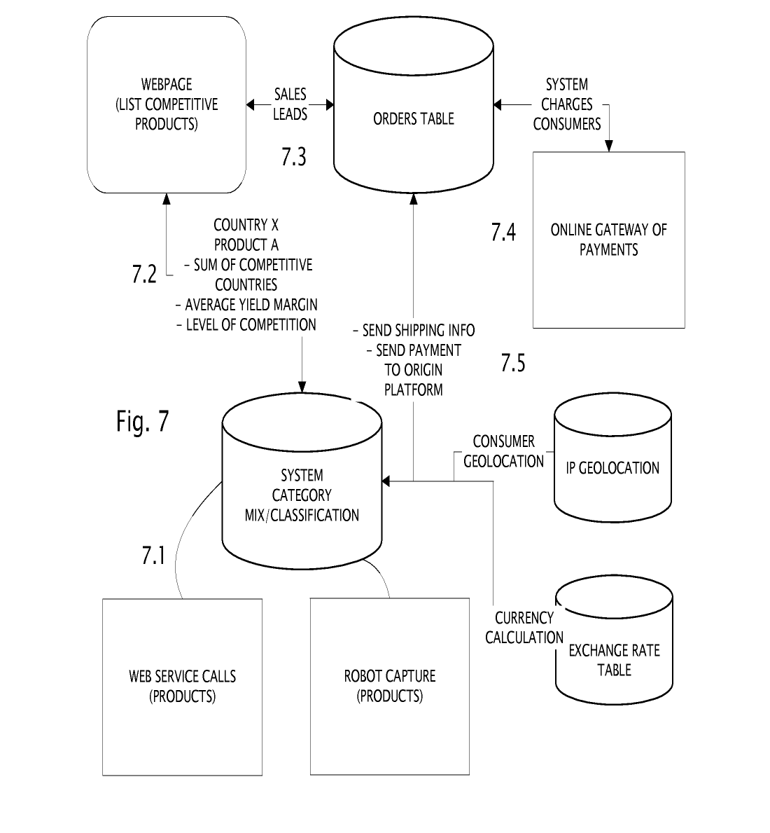

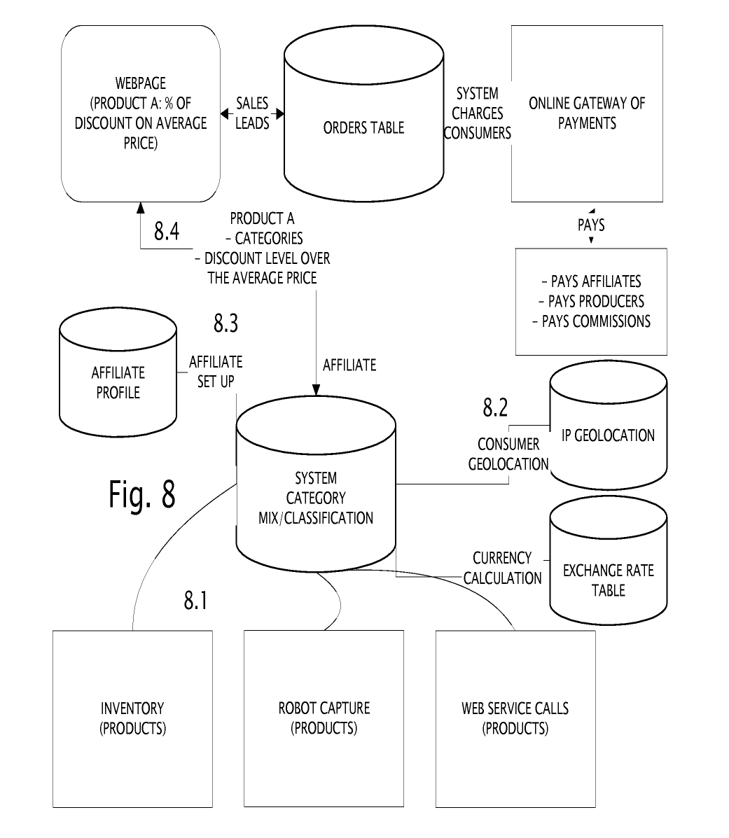

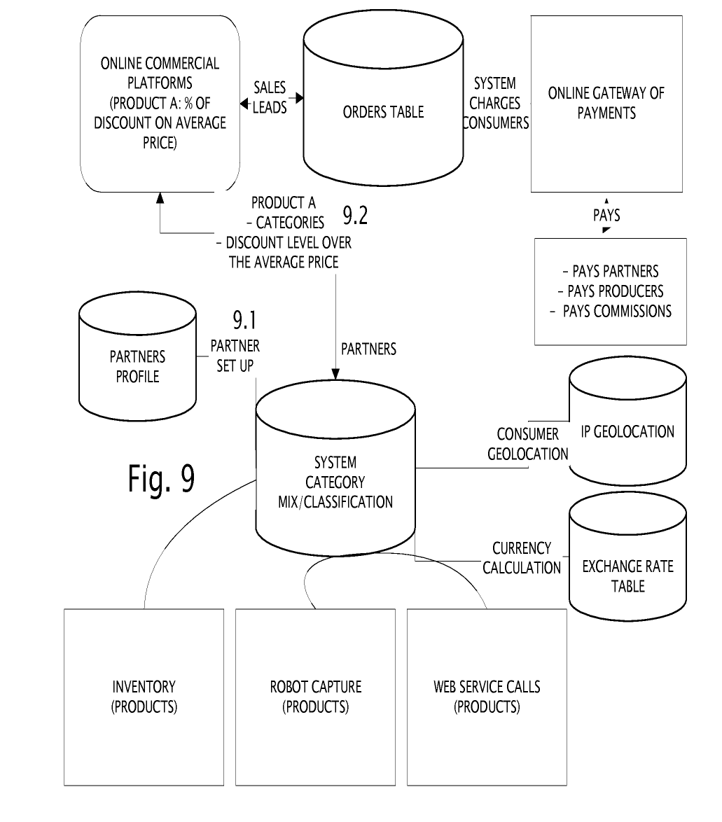

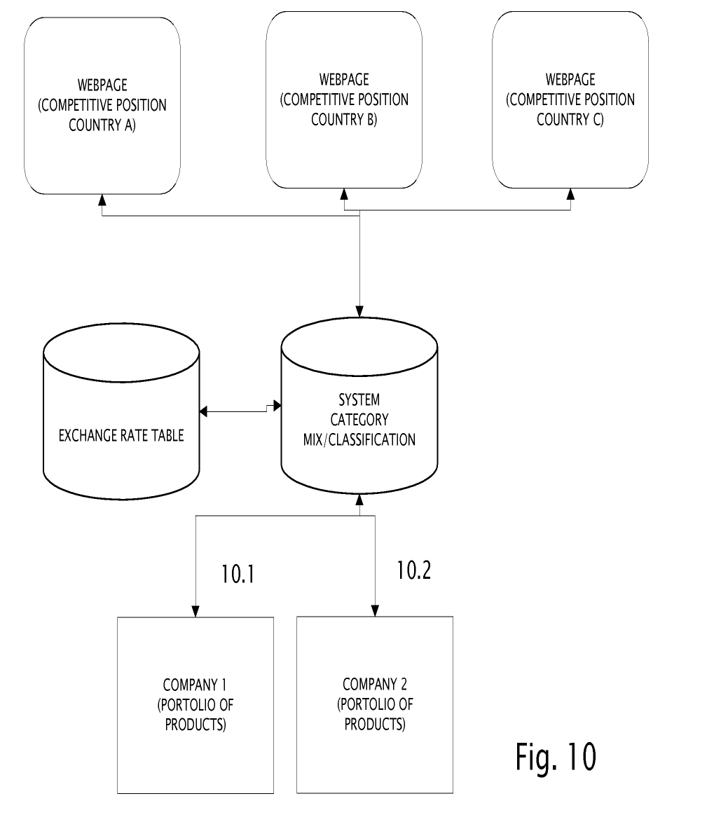

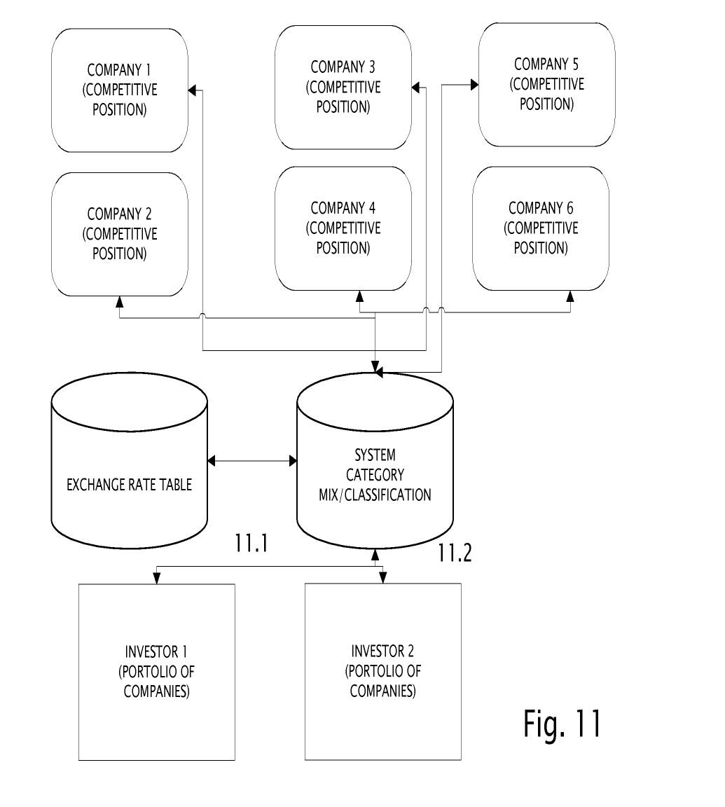

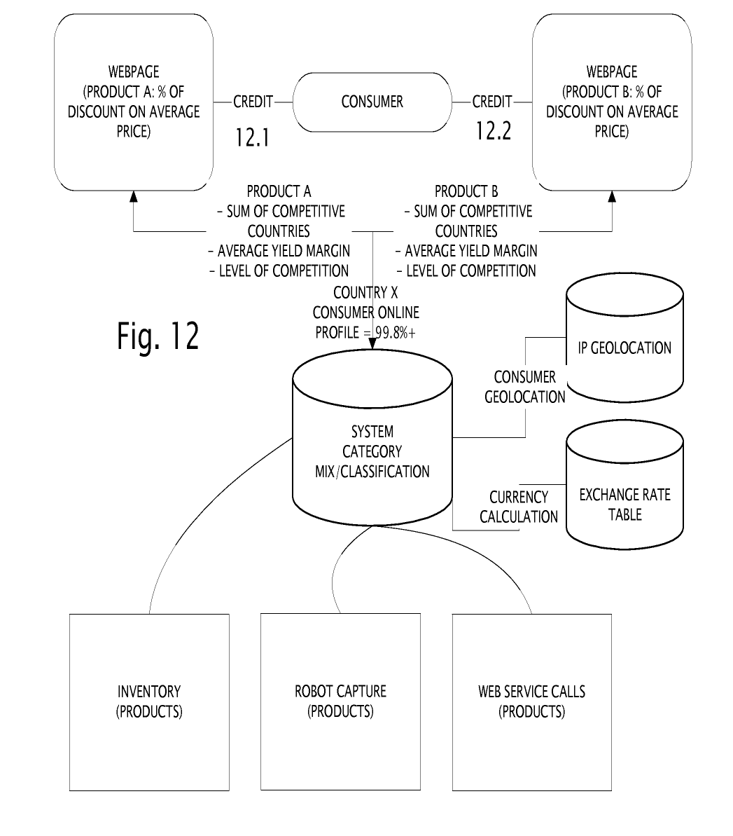

The seller network—comprising FIGS. 1, 2, 3, 4—focuses on users selling their products worldwide using the global competitive position of products to find their competitiveness on different markets. The system lets them know where to sell their products at the best price.

The buyer network—comprising FIGS. 5, 6, 7—will allow users to access the best prices available worldwide for products delivered directly door to door, and credit through our financial network through the determination of the global competitive position of consumers.

The affiliate—partner network—comprising FIGS. 8 and 9—focused on the promotion of these products, where participants register in the platform, with the goal of receiving the margin at destination of each product sold by their commercial effort, calculated by the global competitive position displayed by the products that they promote.

Finally, the financial network—comprising FIGS. 10, 11 and 12—will be focused on the determination of:
Global competitive position of a Company: offering a tool to estimate the competitiveness of a company based on the sum of global competitiveness of products manufactured by them, plus the potential based on average price margin and number of countries in which those products show a positive competitive position.
Global competitive position of an Investor: offering a tool to estimate the competitiveness of an Investor or advisory firm, based on the sum of global competitiveness of the companies which make up their portfolio. This tool gives an determination of the capabilities that this participant has to obtain benefits from all over the world.
Global competitive position of Consumers: For Online consumers requesting credit in order to acquire products. This let us know the global competitive position of a consumer based on their location and online profile to broaden commercial proposal incorporating credit.

In order to explain the system, it is important to make it clear that the most important part of understanding the global competitive position conversion process resides in the analytic analysis for products and categories. The global competitive position category mix and classifications table operate as a HUB for all operations performed in the system. To develop operations, global competitive position system analyzes each product category based on the following premises:
Each product/category is analyzed in terms of constitutive characteristics in order to standardize the duties and taxes process.
Global customs analysis to define the type of logistical processes that will be needed in order to operate with that kind of product. This means analyzing restrictions and legal requirements for each category.
Incorporation of each new product into the global competitive position category tree. Each new product category will be linked with other categories on major commercial platforms around the world.

This analysis will be used in the four operational logics at the system. Beginning with the seller network, the system analyzes the competitive position of a product comparing the delivery duty paid price of a product located in another country, versus the price of similar or equal products located in the same country, in order to define the price spread shown as we can see on FIG. 1. The module estimates the yield margin of a product in other countries, based on 3 variables:
The origin country of the product—contained on step 1.1—.
Origin price of the product (FOB Price)—contained on step 1.1—.
The characteristics each product has that can be standardized using harmonized code in each destination country—step 1.2—.

Through these three variables we can determine the price value in order to proceed with the comparison between the delivery duty paid price (DDP) of the product located in a foreign country—step 1.3—, versus the average price—step 1.4—displayed by similar products located in the market of analysis.

In order to estimate the delivery duty paid—DDP—price of the product located in one country and delivered in another the following calculations must be made.—step 1.3—. Using examples and information provided by Export.gov United States Governmental Agency, there are two generally accepted methods for calculating duty rates: CIF and FOB. Most countries use the CIF method. Some exceptions may apply. VAT (Value Added Taxes) is generally applied on the CIF or FOB+Duty value. The global competitive position system will use each method based on destination countries choices. On the other hand, the system operates using web services and robot data capturing information in order to estimate price averages on destination locations. These average price calculations will be calculated by automatic and manual determination performed by the participant operating in the platform—step 1.4—.

This comparison between the delivery duty paid price and the average price of similar or equal products—step 1.5—will show three possible results—a positive, negative or neutral competitive position—, that will let us know if it is worthwhile to make a commercial effort and promote in the market of analysis. This analysis provides participants an appreciation of the benefit to be received for the promotion and sales of these products in a particular market.

The second figure explains the way we can estimate the global competitive position of a product in other countries around the world. By using the same kind of calculations performed and explained on FIG. 1, this analysis compares the amount of money a consumer will pay for a product located in another country, to receive these goods door to door on their countries—including the duties and taxes—, vs. the average price of similar or equal products located in their country. Consequently, these analyses provide sellers with a multinational approach to estimate the global competitive position of their products on other countries, letting them know in how many places these products are competitive and at what price margin. This information offers the possibility to promote products that they know to be competitive. In order to explain the functionality of the seller network and the following steps that are accomplished by participants we will refer to FIG. 3.

The global competitive position category mix—classifications table operate as a HUB for all the Sell module operations as stated on FIG. 3. The whole information of harmonized tariff codes and tree of categories from different online commercial platforms is stored in the category mix/classifications table. The systems operation—step 3.1—begins with Companies and producers listing their products in the inventory/product manager area on the system. This action will include:
Title and description of their products.
The FOB Price of each product listed on the system.
The category covering each product in global competitive position system category list.
The physical location of the product.

On the step 3.2 we can observe the system administrating the global competitive position of each product, identifying markets that these products are competitive in.—Detailed explanation on FIGS. 1 and 2—.

In the Analyze page the local price, location and category of each product will be offered from the inventory manager. On the other hand, information gathered through web services calls and robot extraction will be offered on the Analyze page—step 3.3—. The comparison between these two sources of information provides sellers with the determination of the global competitive position of their products around the world.
The inventory area feeds information to the analyze web page, and to the sell web page
The Inventory manager feeds the Sell module all the necessary information to list a product on any countries where the global competitive position system operates.

In order for all products to be listed in the inventory manager using the local currency, an interaction with the rate of exchange table must be made to establish the sale price in local currency of the target commercial platform.—step 3.4—

The third part consists of Sellers promoting products in competitive markets—step 3.5—. International sellers using the same kind of commercial platforms, the same kind of payment systems, and the same kind of logistical systems as used by local sellers, list products on major platforms through the system and ship directly from their locations to consumers all over the world.
Sellers list their products through the system platform.—step 3.5.—

The system can place listings on major commercial platforms by using our category mix structure, assigning the correct category at destination to any product listed using our business logic. Web pages offer two functions to the proposed system, they provide us with the possibility to list products to be promoted and sell them through their commercial platforms, and gather information to estimate price averages for similar or equal products at destination by robot extraction or web services calls.

On the Step 3.6 we can observe the system administrating products exposure, when companies list their products, the system automatically generates a landing page for each product listed in the system. This page show two types of contents, one content for sellers and the other content for consumers. Seller's content allows them to estimate the competitive position of each product and administer their promotion and sales campaigns all over the world. Consumer's content shows all the information about that product, and the check-out button to purchase it.

Through this page:

First, Sellers will be able to analyze the global competitive position of their products on each market through:
The systematic scan and collection of information, to show tendencies and average prices on products and categories all over the world.
The manual selection performed by sellers over equal or similar products, to estimate at a glance, the average price of singular products or categories. This information will be saved on the product profile for trend analysis.
Lists products through the major commercial platforms, pressing each button that represents them for any country that the system operates in, within the same page.

Second, Consumers will be able to:
Analyze the product description and sales conditions through product landing page.
Acquire the product through the check-out process.

This page works as a landing page for sales leads coming from other commercial platforms, comparison engines, affiliates programs or social networking sites. On figure four we show the way Sales leads are channeled towards global competitive position online payment gateways. On step 4.2 the system shows the way it receives orders—step 4.1—, at system orders table, and offers sellers the possibility to charge consumers and print shipping labels—step 4.4—, to ship commodities around the world. Products are delivered door to door with a similar transit time—24 hs up to 96 hs—to products sold and delivered locally in other countries. Companies ship products from their locations:

Each company or manufacturing location print export documents—awb's and commercial invoices—; when products are ready to ship the Courier services company will pick up all packages at the manufacturer location. Courier services companies' pickup, ship and deliver door to door all packages with a transit time between 24 hs. up to 96 hs. to cover the entire world. If a Seller charges the consumer but he/she needs more time to prepare and ship products (maximum time 48 hs), the shipping order will be stored at the Ship page to be printed later. After the printing operation, orders will remain in the track history table—step 4.5—. Sellers can check and track the status of their shipments through major courier services.

Consumers receive their purchased products and give feedback to the commercial platform or to the system. The global competitive position system orders table sends information about the amount of the transaction to the account balance/transfer module—step 4.3—. Sellers receive their payments in their bank account or by a cashier check request, based on their preferences—step 4.6—.

Analyzing the Buyers' network, the system offers consumers the best price available for products located throughout the world. At an analytical level, the buyer's network offers consumers, products available throughout world, customized in price for their locations through three variables:
Consumer Geo-location—the place where this consumer is located around the World detected by Internet protocol Geolocation methods.
Level of Competition—commercial turbulence that a product presents/displays in a particular market.
Online profile of the consumer.

On FIG. 5 we can observe the system displaying product information stored on local databases and through web services calls to major commercial platforms—step 5.1 and Step 5.2—, the system will estimate the price of products delivered directly to the door of a consumer in a particular market. In this model the system displays international products using a percentage of discounts over the average price of similar products on that category in that location. This variable will be defined manually or through the determination of the category competition of products available for that consumer in a particular market.
The module estimates the competitive position of a consumer based on 4 variables:
Sum of countries where this consumer could acquire price competitive products.
Sum of products available for this consumer in a particular category.
Price margin or average yield these inventories have in this category and consumer location.
Online profile of a consumer based on positive feedbacks in other platforms.

This analysis lets us know the level of competition that a product shows in a particular market and lets us estimate the possibilities of this commercial message reaching the consumer. With a greater level of competition, we can broaden this proposal incorporating greater discounts or credit to attract his or her acquisition preferences. Based on the online profile of a consumer—we refer to positive feedbacks on different platforms gather through robots and web services calls
step 5.2—we can broaden proposals for this particular consumer with a greater positive feedback profile and therefore better prices on products through discounts over the average price. The graphic explains the way the system shows products on our web page for a particular consumer. In order to explain further we will use an example. Analyzing product type A—step 5.3—, we estimate an average yield of 36.33%, 4500 products available with a DDP price below the average price, and three countries where these products are located. Based on this analysis, we can estimate that the chances to reach a consumer with one of these products are low, giving us the chance to use that information and broaden the commercial proposal with more discounts in price over the average price. In this case we decide to expand by 19% the price reduction of international products over the average price. So when this particular consumer navigates the global competitive position system web site, all products shown will have that amount of discount over the average price of this category. Analyzing products type B—step 5.4—, we estimate an average yield of 26%, 700 products available with a DDP price below the average price, and one country where these products are located. Based on this analysis, we can estimate that the chances of reaching a consumer with one of these products are high, giving us the chance to use that information and broaden the commercial proposal with only a 7% discount in price over the average price. When this particular consumer navigates the system web site, all products shown will have that amount of discount over the average price of this category.

Compared with the current situation, traditional commercial platforms show the same results for all consumers, as we observed. On the global competitive position system, each product is customized for each particular consumer based on the four variables we have previously stated. This means more loyalty from consumers, more acquisitions means better prices for them.

On FIG. 6 we can observe another feature of the system; this logic comprises the alert system for consumers. With this functionality, the global competitive position system allows consumers to set up their choices of products and the maximum price they are willing to pay—step 6.1—. If a product located anywhere around the world reaches that price, the consumer receives a notification or direct purchase based on his set up preferences.

On FIG. 7 we can observe another feature of the system, the global competitive position Spread System. The global competitive position spread system is a model that arbitrates between markets. The Global competitive position spread system, using web services calls to major platforms in the world to gather results in a particular category. By means of those calls we load all the fields that each product has, analyzing the price as FOB price for the logic of our system,—step 7.1—. Products are analyzed by the system in order to find price spreads—step 7.2—These products are analyzed by the global competitive position system finding the ones that are competitive in different markets—DDP price below average price in the same category—and lists the competitive ones in other platforms and countries to obtain the price margin. With the idea of being competitive, the global competitive position system lists products with a percentage of discounts, compared with similar products at each location. The global competitive position lists and promotes those products using our own user id in each platform and country. Actual web services provide the amount of stock remaining for a product, when stock runs out, the global competitive position system closes the commercial proposal. When a consumer in another market acquires a product, sales leads come from commercial platforms,—step 7.3—directly to our landing page or gateway of payments. Consumers pay the destination sales price—greater than DDP price but lower than average price—in our gateway of payments—step 7.4—. At the same time, the global competitive position buys the product at the origin platform and pays the FOB price to origin seller—step 7.5—. The global competitive position system communicates to the seller where we want to deliver that product. When our consumer gives us feedback about the commercial transaction, we use the same information and feedback for the seller.

Analyzing the affiliates and partners' network, the system focuses on the promotion of products, with the goal of receiving the margin at destination of each product sold by the participant commercial effort. The affiliate—partner functionality brings to participants a platform to promote competitive products—analysis based on price comparison directly to consumers in each location that they are operating in. At an analytical level, the global competitive position feature for affiliates—partners brings to affiliates and partners products available throughout the entire world, customized in price for their target locations. When we consider the global competitive position of a product, we can estimate the price margin at destination a product has compared with similar products available in those markets. This price margin at destination allows us to develop a promotional system for products, bringing the margin at destination to participants who make the commercial effort, paying producers the FOB price of each product sold. The global competitive position system separates the commercial capacity of a company from the commercial capacity that a product manufactured by this company has in the world. This separation brings the possibility to promote competitive products by affiliates, partners or even the global competitive position system. We consider that the commercial capacity and budget of a company to promote products is limited. Producers usually show greater capacity in making products than in promoting products. On the other hand, affiliates and distributors present greater capacity in the promotion of products than in making them. This system obtains the best of both worlds—talent to develop them and talent to promote them. Considering that the global competitive position system is a commercial selling system, each product listed on the platform with a FOB Price can be purchased at that price in the origin country. All participants accept this condition. This means that the commercial effort could be made by sellers, affiliates, partners or even the global competitive position system itself. Affiliate's model consists in a system that provides advertising feeds to participants, delivering the best prices in products available worldwide for a consumer in a particular location. Affiliates model analysis is based on three variables:
Consumer Geo-location—the place where this consumer is located around the World detected by Internet protocol Geolocation methods—step 8.2—.
Categories in which participants take part to promote their products.—step 8.3—.
Discount level below average price in a particular category, selected by the affiliate.—step 8.3—.

Participants at the global competitive position affiliate module promote products with a previous knowledge of the price margin in other markets. They already know that these products reach other markets with a DDP Price below the average price in that category. This brings to participants the best choices for earning profits with their commercial efforts. The global competitive position system for affiliates:
Offers a tool to estimate value proposal for customers;
Each player sets a discount margin over the average price on a category/product;

As we can infer, affiliates participate in the commercial process using their knowledge to set the price of the product. As we can see, this graphic explains the way we can provide feeds for a particular web page from different inventories around the world. Through the determination provided by the global competitive position, the global competitive position system brings to affiliates different margins on inventories.—Step 8.1—. The global competitive position for affiliates—partner system plans to provide greater margins first for each category and market. This grants affiliates greater benefits for their commercial efforts. To explain further, the variation in margins will impact affiliates' benefits but not product prices. Our feeds will present in the affiliate's web pages the same sale price for a product during the whole campaign, but these products come from different inventories around the world offering different margins As we can see on—step 8.4—. and explain with an example, when the stock of product A—eg: cd players—available in a foreign country expires, we will deliver product A available in other countries—eg; Country B—, but displaying a lower margin at destination of each product promoted and sold.

This situation brings us the possibility to cover all aspects of the campaign for a particular affiliate. We assume these products will be promoted by many affiliates in the product A category, so this plan (different inventories covering a campaign) decreases affiliate risk. On the other hand, when a partner promotes a product, we use the same kind of determination as we did with the seller module. The following calculation will apply: FOB Price+duties and taxes=DDP Price. The global competitive position will be estimated as: average price less DDP Price=Margin at destination. Affiliates—partners will receive margin at destination, producers will receive FOB price. The global competitive position system will receive commission based on these margins.

Partner's model consists in a system that provides participants with the possibility to earn the margin at destination for each product sold by them, through listings in major commercial platforms and advertising campaigns paid by these participants. Partner's model analysis is based on two variables:
Markets and categories in which participants take part to promote their products.—step 9.2—.
Yield margin and discounts level in a particular category, selected by each partner.—step 9.2—.

Following the same kind of operational procedure to select categories that affiliate's do, on FIG. 9 we can observe the way Partners will spend money to advertise and promote competitive products through major platforms—step 9.2—. For these participants, it is a balance point equation, over the amount they spend; all the rest is benefit. It is important to make it clear that Affiliates—partners do not acquire the product, participating in the platform they acquire the possibility to sell that product. In a typical sales order procedure, the supplies of the consumers are channeled towards the global competitive position system by the commercial platforms and affiliates web pages to our gateway of payments. When a consumer acquires a product, a sale order is generated and reported to the seller company:
Our gateway of payments processes the transaction and each participant receives their payment, less charges and commissions of the global competitive position system. Producers and sellers receive FOB price and affiliates receives margin at destination. A precise amount of money is assigned for duties and taxes. Participants could receive their money by direct transfer to their bank accounts if they have a merchant id or by a monthly transfer with all transactions performed.
Seller Companies, following the same kind of procedure used on the sellers' network, ship products from their locations:
Each company or manufacturing location print export documents—awb's and commercial invoices—; when products are ready to ship the courier services company will pick up all packages on the manufacturer location.
Courier service companies pickup, ship and deliver door to door all packages with a transit time between 24 hs. to 96 hs., covering the entire world.

Consumers receive their purchased products and give feedback to the commercial platform or to the global competitive position system.

Analyzing the financial network, the global competitive position system offers a tool to estimate the competitiveness of a company based on the sum of global competitiveness of the products manufactured by them, plus the commercial potential that this company shows based on an average price margin and number of countries in which those products show a competitive positive position. The system offers a tool to estimate the competitiveness of an Investor or Venture capital firm, based on the sum of global competitiveness of the companies which make up their portfolio. This tool gives an determination of the capabilities that this participant has, to obtain benefits all over the world. The system offers a tool to estimate the global competitive position of a consumer based on their location and online profile to broaden commercial proposal incorporating credit.

Using these tools and their knowledge of their markets, each participant will set discounts over average prices in the selected categories of products where he enrolled to promote:
If the discount is closer to DDP price, possibilities to sell each product are greater and possibilities to earn money are smaller.
If the discount is closer to average price, possibilities to earn money on each product are greater and possibilities to sell are smaller.

On FIG. 10 we can observe the first feature offered for financial operations. This feature provides investors with an analysis of the global competitive position of a company based on the sum of global competitiveness and price margin available in their portfolio of products. In the graphic provided on FIG. 10, we compare two companies located in different countries selling similar products to the entire world. The global competitive position system, through our method, can determine the global competitive position of these companies, based on the sum of competitive products plus the sum of countries where those products are competitive.

Analyzing each company and using an example to provide further details of the operation, the first company—1—sells two products—step 10.1—. The average price margin for product A is 22% and there are 6 countries where this type of product is competitive. The average price margin for product B is 36% and there are 3 countries where this type of product is competitive. The level of competition show 3500 products competing with this company portfolio at the same competitive target markets. Company 2 sells similar kinds of products. The average price margin for product A is 18% and there are 2 countries where this type of product is competitive. The average price margin for product B is 25% and there are 3 countries where this type of product is competitive. The level of competition show 8500 products competing with this company portfolio at the same competitive target markets. As we observe, the global competitive position of Company 1 is greater than the global competitive position of Company 2—step 10.2—, offering similar products to the world but manufactured in different locations. Consequently, using these determination tools, specialized investors can infer that the possibility of Company 1 to generate more profits in the world is greater than the possibility Company 2 has, orienting their investments to companies with higher competitive position.

The second feature that we will analyze is the global competitive position of an investor based on the sum of global competitiveness and price margin available in their portfolio of products. In the graphic provided on FIG. 11, these two investors put their money in companies located around the world. Global competitive position system, through our method, can estimate the global competitive position of investors, based on the sum of global competitiveness of the companies which make up their investment portfolio. Analyzing step 11.1 we will see the following situation—example by using a simulation of an investor 1 investing on three companies located in different countries. For this example, the average price margin for company 1 is 22% and there are 6 countries where this company is competitive. The average price margin for company 2 is 36% and there are 18 countries where this company is competitive. The average price margin for company 3 is 33% and there are 12 countries where this company is competitive The average yield margin for this investor is 30% and the level of competition shows 7500 products competing with this company portfolio within the same target markets. On the other hand, Investor 2—step 11.2—put his money in three companies. The average price margin for company 4 is 22% and there are 8 countries where this company is competitive. The average price margin for company 5 is 25% and there are 10 countries where this company is competitive. The average price margin for company 6 is 28% and there are 12 countries where this company is competitive. The average yield margin for this investor is 25% and the level of competition shows 16500 products competing with this company portfolio within the same target markets. As we observe, the global competitive position of Investor 1 is greater than the global competitive position of Investor 2, operating within the same category. Consequently, manufacturing companies looking for partners that will become contributors can infer that the possibility of Investor 1 to contribute to their business is greater than the possibility Investor 2 has, orienting their contacts to investors with higher competitive position. Finally, the third feature that we will analyze is the Global Competitive Position of a Consumer to provide credit based on his online profile and market competition. As is observed on FIG. 12, the global competitive position of a consumer varies according to categories, bringing a different amount of credit to the same consumer based on competition—turbulence level available in each category. Analyzing each consumer and using an example to provide further details of the operation, we estimate an average yield of 29%, 3000 products available with a DDP price below the average price, and 2 countries where these products are located. Based on this analysis, we can estimate that the chances to reach a consumer with one of these products are low, giving us the chance to use that information and broaden the commercial proposal with more credit. In this case we decide to offer a credit plan of 6 months with 0% interest to acquire that product, so that when this particular consumer navigates the web site, all products shown will have that amount of credit on this category—step 12.1—. Analyzing products type B, we estimate an average yield of 26%, 700 products available with a DDP price below the average price, and 1 country where these products are located. Based on this analysis, we can estimate that the chances of one of these products to reach a consumer are high, giving us the chance to use that information and broaden the commercial proposal with credit. In this case, we decide to offer a plan of 3 months with 5.5% of interest to acquire that product—step 12.2—, so that when this particular consumer navigates the web site, all products shown will have that amount of credit on this category.

What is claimed is:

1. A computer implemented method for carrying out an international electronic commerce operation comprising:
a system to perform a determination of a global competitive position of a product, wherein the determination consist on the comparison between the delivery duty paid price (DDP) of a product versus the average price of similar products located in another country.

2. The method of claim 1, wherein each product is incorporated into a category tree, wherein each product category will be created taking into consideration product constitutive characteristics and linked with other categories displayed on major commercial platforms around the world that take into consideration equal constitutive characteristics for the same kind of products.

3. The method of claim 1, wherein the delivery duty paid price of each product is performed based on 3 variables:
origin country of the product;
origin price of the product (FOB Price); and
constitutive characteristics of each product which can be standardized using harmonized code in the destination country.

4. The method of claim 2 or 3, where each product is assigned to a product category based on its constitutive characteristics based on the following premises:
the category of the product is analyzed in terms of constitutive characteristics of the product to standardize duties and taxes processes; and
the product is analyzed using global customs analysis to recognize restrictions and legal requirements, defining the possibility to operate using express mail services or through a formal clearance entry on the country of analysis.

5. The method of claim 1, wherein the average price of each product is determined by providing feeds of information about similar or equal products gathered through major e-commerce platforms around the world, wherein each user can select by automatic and manual determination, similar or equal products that perfectly match their product's features in order to estimate the price average on the market of analysis.

6. A computer implemented method for carrying out international electronic commercial transactions comprising a centralized environment for participants to process worldwide sales based on the global competitive position determination.

7. The method of claim 6, wherein the centralized environment gives the functionality for sellers to place sales leads by providing different buttons to list positive global competitive position product through major commercial platforms, wherein these buttons represent similar or equal categories on each commercial platform operating around the world.

8. The method of claim 6, wherein the centralized environment gives the functionality to determine the price that the buyer will pay for each product based on the following variables for the determination:
sum of countries where this consumer could acquire price competitive products;
sum of products available for this consumer in a particular category;
price margin or average yield that a product displays in this category and consumer location; and
online profile of a consumer based on positive feedbacks in other platforms.

9. The method of claim 6, wherein the centralized environment gives the functionality for the buyer to set up the maximum price he is willing to pay, where if a product located around the world has a positive global competitive position, the buyer receives a notification or direct purchase based on his set up preferences.

10. The method of claim 6, wherein the centralized environment arbitrates products between markets, where products are analyzed by the global competitive position system finding the ones that display positive global competitive positions and listing them in other platforms and countries to obtain the price margin.

11. The method of claim 6, wherein the centralized environment provides advertising feeds to publisher participants, delivering the best prices in products available worldwide for a consumer located in a particular geo-location, where the price calculations to be shown on publisher participants' websites is performed taking into consideration three variables:
consumer geo-location;
categories in which publisher participants take part to promote products; and
discount level below average price in a particular category, selected by the publisher participants.

12. The method of claim 6, wherein the centralized environment provides advertising feeds to publisher partners, delivering the best prices in products available worldwide for a consumer located in a particular geo-location, where the price calculations to be shown on partners' websites is performed taking into consideration three variables:
markets and categories in which participants take part to promote their products; and
yield margin and discounts level in a particular category, selected by each partner.

13. A computer implemented method for carrying out an international financial platform for manufacturing and retail companies comprising:
the determination of the global competitive position of a company, analyses based on the sum of competitive products plus the sum of countries where these products are competitive.

14. The method of claim 13, wherein the assigning includes:
the determination of the global competitive position of investors, analyses based on the sum of global competitiveness that the companies which make up their investment portfolio display.

15. The method of claim 13, wherein the assigning includes:
the determination of the Global Competitive Position of a Consumer in order to provide credit based in his online profile and the market competition determination, displayed for that particular product in that particular location.
